(19) United States
(12) Patent Application Publication
(10) Pub. No.: US 2021/0224366 A1
(43) Pub. Date: Jul. 22, 2021

(54) SYSTEM AND METHOD OF MANAGING ELECTRIC POWER EQUIPMENT HAVING BIOMETRIC INFORMATION RECOGNITION FUNCTION

(71) Applicant: DIK Co., Ltd., Gangwon-do (KR)

(72) Inventors: Byung Kwan KANG, Seoul (KR); Seoung Uk JEON, Gangwon-do (KR)

(73) Assignee: DIK Co., Ltd., Gangwon-do (KR)

(21) Appl. No.: 16/309,827

(22) PCT Filed: Sep. 27, 2018
(86) PCT No.: PCT/KR2018/011358

§ 371 Date: Dec. 13, 2018

(30) Foreign Application Priority Data
Aug. 23, 2018 (KR) 10-2018-0098298

(51) Int. Cl. G06F 21/32; H05K 5/00; H05K 5/02

(52) U.S. Cl. CPC G06F 21/32; H05K 5/0247; H05K 5/0017

(57) ABSTRACT

Provided are a system and method of managing electric power equipment having a biometric information recognition function, for preventing the risk of an accident by installing an examination unit for directly examining and checking important checklist items along with a biometric information recognition unit for recognizing biometric information of a safety manager, in the electric power equipment, in order to periodically manage the electric power equipment.

### TECHNICAL FIELD

The present invention relates to a system and method of managing electric power equipment, and more particularly, to a system and method of managing electric power equipment having a biometric information recognition function for periodically managing the electric power equipment using biometric information such as a fingerprint or iris to prevent the risk of an accident.

### BACKGROUND ART

A distribution board or a panel board, a motor control board, an inverter (power converter), a connection board, an ESS, or the like is configured by installing various electrical controllers, a connector for connection therebetween, and a control panel including a switch for control of the controller, a meter, and the like, in a body in a metal housing.

The distribution board is a device for positioning a predetermined number of switches, measurement instruments, relays, and the like and managing them for an operation and control of an electric power station, a substation, or the like or an operation of an electric motor, and is classified into a distribution board for a main circuit and a distribution board for control.

A main distribution board of a substation for industrial or domestic use is the distribution board for a main circuit, and a distribution board for manipulation to be applied to the latest electric power station or the like is a the distribution board for control.

Viewed from the front of the distribution board of the substation for domestic use, there is a control lever for opening and closing a breaker of a high-tension main circuit, an air break switch of a low-tension main circuit, a voltmeter, an ammeter, a wattmeter, an integrating wattmeter, an eddy current relay, and the like.

The distribution board is configured to be of an open type or a closed type, and in this regard the open-type distribution board is configured in such a way that electric wiring, switch terminals, and the like are exposed through a rear surface of a main body, and the closed-type distribution board is configured in such a way that all components are installed in a painted steel box and only a minimal number of measurement instruments, manipulation buttons, and the like are externally exposed to the outside. In the case of the open-type distribution board, units have standardized dimensions, and thus the number of units is determined depending on the size of a substation and the like.

The panel board is configured in such a way that switches for respective branch circuits are installed at points of a main line, which is branched into the branch circuits in the case of interior wiring, and in this regard, a panel board of a house is simply configured by disposing and fixing a cut-out switch, but in the case of a panel board of a building, panel boards formed of steel are installed in a wall, and doors for complete opening and closing are installed in the wall of respective floors, i.e., at least one floor.

In the case of wiring inspection, repair, remodeling, etc. indoors, a branch switch in a corresponding room is separated from a panel board to shut off the power.

In the prior art, a knife switch with a fuse installed therewith is installed in each branch circuit, and in the more recent art, a tumbler switch and a plug-type fuse are used.

In addition, as described above, the motor control board is configured in such a way that various controllers and the like are installed in a body on a housing to effectively control and operate target devices and systems using a switch, a meter, and the like, which control the devices and systems.

The distribution board includes very important equipment installed therein for supplying electricity to houses or major facilities such as a large building or a factory, and thus only a specific manager who has learned how to safely work with the distribution board is able to open a distribution board door and to perform operations on components inside the distribution board.

In order to periodically manage electric power equipment including a distribution board, a safety manager examines a display installed on a front surface with the naked eye to recognize an operational state thereof.

However, in the case of conventional electric power equipment, a limited number of safety managers manage and examine a large number of power facilities with the naked eye, and thus the electric power equipment may not be managed normally despite being continuously operated, thereby increasing the risk of an accident.

In addition, even if the electric power equipment is examined using a checklist, when a layperson, rather than a safety manager, performs formal checking according to the checklist or checks records without performing a site visit, the risk of an accident is accordingly increased.

### DISCLOSURE

### Technical Problem

An object of the present invention devised to solve the problem lies in a system and method of managing electric power equipment having a biometric information recognition function, for preventing the risk of an accident by installing a biometric information recognition unit for recognizing biometric information of a safety manager along with an examination unit for directly examining and checking important checklist items in electric power equipment for periodic management of the electric power equipment.

### Technical Solution

The object of the present invention can be achieved by providing a management system for electric power equipment having a biometric information recognition function, including a display unit configured on one surface of the electric power equipment to check an operational state of the electric power equipment, a biometric information recognition unit disposed adjacent to the display unit and for receiving input of biometric information of a safety manager therethrough and determining whether the input biometric information of the safety manager matches pre-registered biometric information of the safety manager, a checklist unit displayed on a screen of the display unit when the biometric information input through the biometric information recognition unit matches biometric information of the biometric information of the safety manager, a controller for controlling an operation of the electric power equipment when the biometric information of the safety manager is not verified within a predetermined time period through the biometric information recognition unit, a switching unit for turning on or off the operation of the electric power equipment under control of the controller, and a storage unit for storing a checking date and time along with corresponding data in the checklist when touch input corresponding to checklist items on the checklist unit is performed.

In another aspect of the present invention, provided herein is a management method of electric power equipment having a biometric information recognition function, comprising a biometric information recognition unit and a display unit for checking an operational state, the method including inputting biometric information to the biometric information recognition unit to determine whether the biometric information matches biometric information of a safety manager of the electric power equipment, displaying a checklist on a screen of the display when the biometric information recognized through the biometric information recognition unit matches biometric information of the safety manager of the corresponding electric power equipment, checking or inputting the checklist displayed on the screen of the display unit to store the checklist, and automatically turning off the electric power equipment when biometric information of the safety manager is not input to the biometric information recognition unit installed in the electric power equipment for a predetermined period.

### Advantageous Effects

A system and method of managing electric power equipment having a biometric information recognition function according to an exemplary embodiment of the present invention may have the following effects.

First, electric power equipment may be periodically managed via examination in order to directly examine important checklist items along with biometric information recognition for recognition of biometric information of a safety manager of the electric power equipment, thereby preventing the risk of an accident.

Second, when a safety manager does not examine the corresponding electric power equipment for a predetermined period, an operation of the corresponding electric power equipment may be stopped to prevent the risk of an accident due to lack of examination.

Third, a safety manager may store examination information in the form of a database via examination based on a corresponding checklist to more safely manage the electric power equipment.

### DESCRIPTION OF DRAWINGS

FIG. 1 is a schematic diagram of a configuration of a management system for electric power equipment having a biometric information recognition function according to the present invention.

FIG. 2 is a flowchart for explanation of a method of managing electric power equipment having a biometric information recognition function according to the present invention.

FIG. 3 is a schematic perspective view of electric power equipment attached to a management system for electric power equipment having a biometric information recognition function according to the present invention.

### BEST MODE

Hereinafter, at least one embodiment of the present disclosure will be described in detail with reference to the accompanying drawings. However, in the following description of the at least one embodiment, a detailed description of known functions and configurations incorporated herein will be omitted for clarity and brevity. In the following description, like reference numerals designate like elements although the elements are shown in different drawings.

The terms and words which are used in the present specification and the appended claims should not be construed as being confined to common meanings or dictionary meanings but should be construed as meanings and concepts matching the technical spirit of the present invention in order to describe the present invention in the best fashion. Accordingly, the embodiments stated in the specification and the components shown in the drawings are merely an exemplary embodiment of the present invention and are not intended to represent all technical ideas of the present invention, and thus, it is to be appreciated that all equivalents and changes that do not depart from the spirit and technical scope of the present invention are encompassed in the present invention when the application is filed.

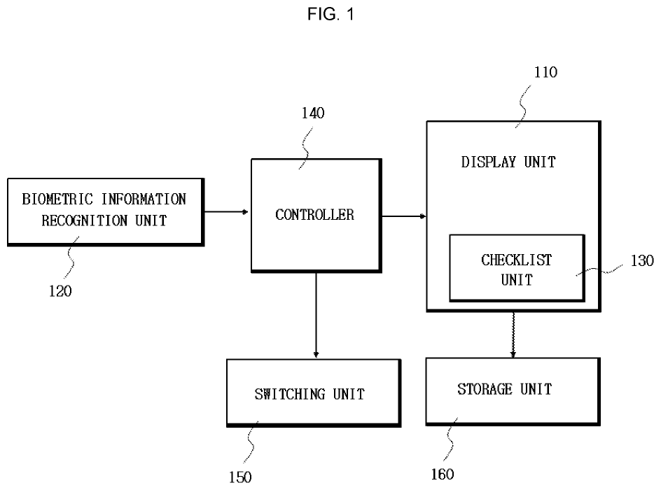

FIG. 1 is a schematic diagram of a configuration of a management system for electric power equipment having a biometric information recognition function according to the present invention.

As shown in FIG. 1, the management system for the electric power equipment having the biometric information recognition function according to the present invention may include a display unit 110 that is configured on one surface of the electric power equipment and checks an operational state of the electric power equipment, a biometric information recognition unit 120 that is disposed adjacent to the display unit 110, is used to input biometric information of a safety manager therethrough, and determines whether the input biometric information matches pre-registered biometric information of the safety manager, a checklist unit 130 that is displayed on a screen of the display unit 110 when the biometric information input through the biometric information recognition unit 120 matches biometric information of the biometric information of the safety manager, a controller 140 for controlling an operation of the electric power equipment when the biometric information of the safety manager is not verified within a predetermined time period through the biometric information recognition unit 120, a switching unit 150 for turning on or off the operation of the electric power equipment under control of the controller 140, and a storage unit 160 for storing a checking date and time along with corresponding data in the checklist when touch input corresponding to checklist items on the checklist unit 130 is performed.

Here, the electric power equipment is configured in such a way that low-voltage and high-voltage distribution boards or a panel board, a motor control board, an inverter (power converter), a connection board, an electronic switching system (ESS), and the like are configured by installing various electrical controllers, a connector for connection therebetween, and a control panel including a switch for control of the controller, a meter, and the like, in a body in a metal housing.

The components installed in the electric power equipment need to be periodically examined in order to prevent accidents, and in this regard, if the service behavior of a safety manager is not appropriate or if a small number of safety managers manage many power facilities, the electric power equipment may be operated for a long time without checking the state of the electric power equipment, thereby creating the risk of an accident.

Accordingly, according to the present invention, the biometric information recognition unit 120 may be installed in the management system, and thus biometric information of a safety manager who is in charge of safety of each piece of electric power equipment may be pre-registered, and the safety manager may input his or her biometric information to the biometric information recognition unit 120 and may then check the state of the electric power equipment.

Accordingly, a problem in which electric power equipment is not adequately managed when electric power equipment is remotely monitored without a direct site visit or in which a layperson checks a checklist may be overcome by checking or inputting each checklist item through the biometric information recognition unit 120 installed in electric power equipment of the corresponding site by a safety manager.

According to the present invention, when internal equipment of the distribution board of the electric power equipment is not appropriately operated by a layperson, a critical accident in which power supplied to an entire factory or large building is shut off may be caused, and thus it is necessary for a safety manager who has taken specialized education to examine and manipulate the electric power equipment, and according to the present invention, a safety manager may be identified in order to ensure safe examination of the electric power equipment through the biometric information recognition unit 120 in the state in which biometric information such as a fingerprint or iris scan is pre-registered.

The display unit 110 may be installed on the front door of the electric power equipment and may easily examine the electric power equipment while viewing an operational state of the electric power equipment. In this case, the display unit 110 may be configured as a touchscreen in order to require the safety manager to input or manipulate information as necessary, rather than being configured to simply provide a viewable screen.

The display unit 110 may display the operational state of the electric power equipment, that is, an internal temperature, an input and output voltage, an accident history, an energy storage state, an operation schedule, and the like. The safety manager may examine the electric power equipment in real time while viewing the screen of the display unit 110.

The biometric information recognition unit 120 uses technology for recognizing and identifying the human through biological and behavioral features that are different for respective people, that is, biometrics for directly extracting information from the human body, including fingerprint recognition, iris recognition, retina recognition, hand geometry recognition, vein recognition, or the like. Biometrics recognized through behavioral features may include voice recognition, signature recognition, gait recognition, or the like.

In general, the biometric information recognition unit 120 may use a method of pre-inputting biometric information of an object through a dedicated recognizer and then comparing the biometric information with information verified by a sensor. There may be various methods such as vital reaction detection as well as simple image comparison.

According to the present invention, the biometric information recognition unit 120 may authenticate a safety manager by determining whether the safety manager is a pre-registered safety manager through detection of a fingerprint of the safety manager, fingerprints being different for respective people.

The biometric information recognition unit 120 may be integrally configured with the display unit 110.

The checklist unit 130 may be displayed on the screen of the display unit 110 when the safety manager is verified as a pre-registered safety manager through the biometric information recognition unit 120. In this case, the safety manager may touch the corresponding checklist to check or input a state of the electric power equipment, and in this case, the storage unit 160 may automatically store a checking date and time along with each checklist item.

For example, when the safety manager is authenticated through the biometric information recognition unit 120, the screen of the display unit 110 may list checklist items such as “1. Is bolt released? YES/NO”, “2. Is cable deformed and discolored? YES/NO”, “3. Is equipment damaged or dusty with dust or other foreign substances? YES/NO”, “4. Examine surge protector (SPD) with the naked eye (SPD needs to be replaced when red light is lit)? YES/NO”, “5. Does moisture pass through equipment? YES/NO”, “6. Examine fuses, breakers, etc. with the naked eye YES/NO”, and “7. Example lamp state YES/NO” along with a title “Regular checklist items of incoming and distribution board”, and the safety manager may check or input corresponding items while examining the electric power equipment according to the corresponding items.

When the safety manager has completed checking and inputting the items and then pushes a save button, a signal indicating that examination is completed may be transmitted to a storage device in equipment or may be transmitted to an external management server to store the checking date and time along with corresponding information in a database.

In addition, the safety manager may be authenticated through the biometric information recognition unit 120 and may then input and store an accident history, a temperature, an input and output voltage, an operational state, and the like of the electric power equipment to the checklist unit 130 of the display unit 110. As described above, the aforementioned input checklist items are stored in the form of a database, and thus, a management server may prevent fault diagnosis or may rapidly handle electric power equipment that needs to be replaced or repaired, thereby preventing an accident.

The electric power equipment needs to be periodically examined, e.g., every day, every week, or every month. Accordingly, safety managers need to be assigned to power facilities and to examine the power facilities on a corresponding checking date. However, when required examination is not performed on time due to poor management of the safety manager, the electric power equipment is continuously operated without regard thereto, thus increasing the risk of an accident.

According to the present invention, the controller 140 may be configured to perform control to turn on or off an operation of the electric power equipment and, in this case, when electric power equipment installed in a corresponding site is not examined for a predetermined period, an operation of the corresponding electric power equipment may be automatically turned off. That is, when the safety manager does not directly visit the site and does not perform an authentication procedure on the biometric information recognition unit 120 for a predetermined time period to manage the electric power equipment, the operation of the electric power equipment may be turned off, and when the safety manager directly visits the site and re-performs the authentication procedure to restart the electric power equipment, operation of the electric power equipment may be turned on, thereby preventing the risk of an accident.

The switching unit 150 may be operated upon receiving a control signal stored in the storage unit 160, and may be a main switch installed in the electric power equipment.

The storage unit 160 may store corresponding checklist information, and may also store a storing date and storing time at which the safety manager has completed checking items of the checklist unit 130 and then pushes the save button. Accordingly, the service behavior of a safety manager may be checked and the electric power equipment may also be more stably driven through the information stored in the storage unit 160.

In addition, the information stored in the storage unit 160 may be transmitted to an external management server in order to examine the electric power equipment installed at respective sites in real time.

The safety manager according to this embodiment of the present invention is merely exemplary, and the present invention is not limited thereto, and, for example, a manager of a maintenance company or an equipment manufacturer may manage the electric power equipment.

The management system of the electric power equipment having the biometric information recognition function according to the present invention may manage electric power equipment and may also change the examination time in the state in which biometric information of a plurality of safety managers is registered.

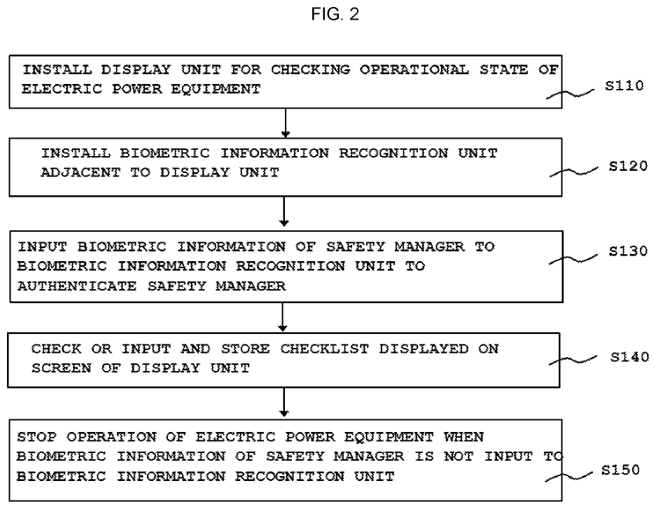

FIG. 2 is a flowchart for explanation of a method of managing electric power equipment having a biometric information recognition function according to the present invention.

The method of managing the electric power equipment having the biometric information recognition function according to the present invention may include installing a display unit for checking an operational state of electric power equipment, as shown in FIG. 2 (S110).

Here, the electric power equipment is configured in such a way that low-voltage and high-voltage distribution boards or a panel board, a motor control board, an inverter (power converter), a connection board, an ESS, or the like is configured by installing various electrical controllers, a connector for connection therebetween, and a control panel including a switch for control of the controller, a meter, and the like, in a body in a metal housing.

Then, a biometric information recognition unit may be installed adjacent to the display unit (S120). In this case, the biometric information recognition unit may store biometric information of a safety manager of the electric power equipment.

The biometric information recognition unit may be integrally configured with the display unit.

In general, the biometric information recognition unit may use a method of pre-inputting biometric information of an object through a dedicated recognizer and then comparing the biometric information with information verified by a sensor. There may be various methods such as vital reaction detection as well as simple image comparison.

Then, the biometric information of the safety manager may be input to the biometric information recognition unit in order to authenticate the safety manager (S130). In this case, in order to determine whether the biometric information input to the biometric information recognition unit matches a pre-registered safety manager, the safety manager may be authenticated by determining whether the biometric information corresponds to biometric information of the pre-registered safety manager through detection of the fingerprint of the safety manager, fingerprints being different for respective people.

When the biometric information recognized through the biometric information recognition unit corresponds to a safety manager of corresponding electric power equipment, a checklist may be displayed on a screen of the display unit.

Then, the checklist displayed on the screen of the display unit may be checked or input (S140).

A door of the electric power equipment including the checklist may be open, an internal temperature, an input and output voltage, whether smoke or oil leaks, whether peculiar smell or sound is generated, etc. may be checked with the naked eye, and the result may be input to the checklist of the display unit.

As the determination result, when the biometric information matches biometric information of the pre-registered safety manager, the checklist of the electric power equipment may be displayed through the display.

When the checklist is completely checked or input, the result may be stored. Then, the stored data may be transmitted to an external management server and may be used as information on whether electric power equipment installed on a site is replaced or repaired.

Then, when biometric information of a safety manager is not input to the biometric information recognition unit installed in the electric power equipment for a predetermined time period, the electric power equipment may be automatically turned off and may not be operated (S150).

To restart the electric power equipment that is not operated, the biometric information of the safety manager may be input to the corresponding biometric information recognition unit, and the method may then proceed.

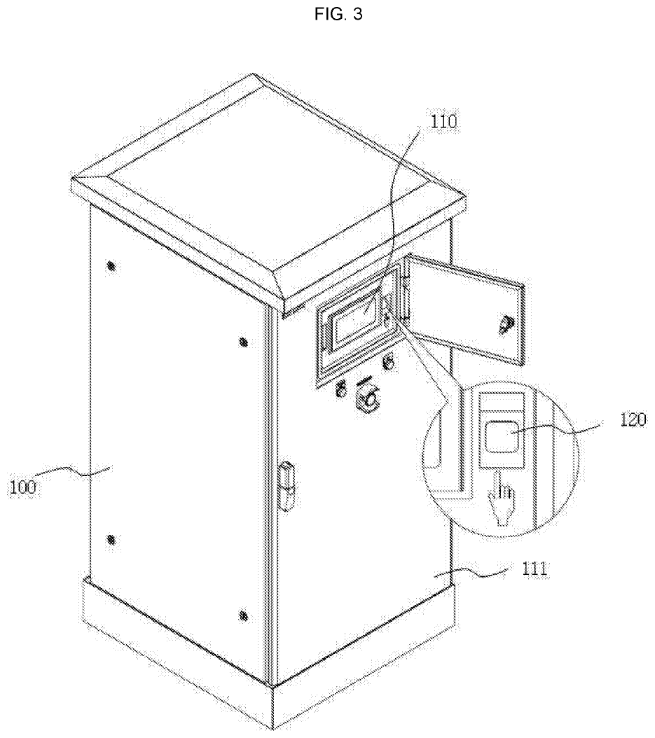

FIG. 3 is a schematic perspective view of electric power equipment attached to a management system for electric power equipment having a biometric information recognition function according to the present invention.

As shown in FIG. 3, the biometric information recognition unit 120 along with the display unit 110 may be installed on the front surface of a door 111 of electric power equipment 100.

To manage the electric power equipment 100, when a corresponding safety manager pre-stores biometric information in the biometric information recognition unit 120, the pre-stored biometric information may be compared with input biometric information to determine whether the input biometric information corresponds to biometric information of the pre-registered safety manager.

When the biometric information input to the biometric information recognition unit 120 matches the biometric information of the safety manager, a checklist of the display unit 110 may be displayed and the displayed checklist may be checked or input to examine the electric power equipment.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### MODE FOR INVENTION

Various embodiments have been described in the best mode for carrying out the invention.

### INDUSTRIAL APPLICABILITY

The aforementioned system and method for managing electric power equipment having a biometric information recognition function may be used in various power facilities such as low-voltage and high-voltage distribution boards or panel boards, motor control boards, inverters (power converters), connection boards, and electronic switching systems (ESSs).

1. A management system for electric power equipment having a biometric information recognition function, the management system comprising:
a display unit configured on one surface of the electric power equipment to check an operational state of the electric power equipment;
a biometric information recognition unit disposed adjacent to the display unit and for receiving input of biometric information of a safety manager therethrough and determining whether the input biometric information of the safety manager matches pre-registered biometric information of the safety manager;
a checklist unit displayed on a screen of the display unit when the biometric information input through the biometric information recognition unit matches the biometric information of the safety manager;
a controller for controlling an operation of the electric power equipment when the biometric information of the safety manager is not verified within a predetermined time period through the biometric information recognition unit;
a switching unit for turning on or off the operation of the electric power equipment under control of the controller; and
a storage unit for storing a checking date and time along with corresponding data in the checklist when touch input corresponding to checklist items on the checklist unit is performed.

2. The management system of claim 1, wherein the electric power equipment includes at least one of low-voltage and high-voltage distribution boards or panel board, a motor control board, an inverter (power converter), a connection board, and an ESS.

3. The management system of claim 1, wherein the biometric information recognition unit is integrally configured with the display unit.

4. The management system of claim 1, wherein the switching unit is a main switch of the electric power equipment.

5. The management system of claim 1, wherein the biometric information is any one of fingerprint recognition, iris recognition, retina recognition, hand geometry recognition, vein recognition, biometrics, voice recognition, and gait recognition.

6. The management system of claim 1, wherein the display unit is configured as a touchscreen.

7. A management method of electric power equipment having a biometric information recognition function, comprising a biometric information recognition unit and a display unit for checking an operational state, the method comprising:
inputting biometric information to the biometric information recognition unit to determine whether the biometric information matches biometric information of a safety manager of the electric power equipment;
displaying a checklist on a screen of the display when the biometric information recognized through the biometric information recognition unit matches biometric information of the safety manager of the corresponding electric power equipment;
checking or inputting the checklist displayed on the screen of the display unit to store the checklist; and
automatically turning off the electric power equipment when biometric information of the safety manager is not input to the biometric information recognition unit, installed in the electric power equipment, for a predetermined period.

8. The method of claim 7, further comprising simultaneously storing a checking date and time when the checklist is stored.

9. The method of claim 7, further comprising transmitting the stored checklist to an external management server.

10. The method of claim 7, wherein the electric power equipment includes at least one of low-voltage and high-voltage distribution boards or panel board, a motor control board, an inverter (power converter), a connection board, and an ESS.

11. The method of claim 7, wherein it is possible to change a checking time of the electric power equipment and to register the plurality of safety managers.
